(19) United States
(12) Patent Application Publication
(10) Pub. No.: US 2017/0260419 A1
(43) Pub. Date: Sep. 14, 2017

(54) POLYSILOXANE FORMULATIONS AND COATINGS FOR OPTOELECTRONIC APPLICATIONS, METHODS OF PRODUCTION, AND USES THEREOF

(71) Applicant: Honeywell International Inc., Morris Plains, NJ (US)

(72) Inventors: Nancy E. Iwamoto, Ramona, CA (US); Joseph T. Kennedy, San Jose, CA (US); Desaraju Varaprasad, Dublin, CA (US); Sudip Mukhopadhyay, Berkeley, CA (US); Songyuan Xie, E Palo Alto, CA (US)

(21) Appl. No.: 15/445,966

(22) Filed: Feb. 28, 2017

Related U.S. Application Data
(60) Provisional application No. 62/307,958, filed on Mar. 14, 2016.

(51) Int. Cl. C09D 183/04; G06F 19/00

(52) U.S. Cl. CPC C09D 183/04; G06F 19/701

(57) ABSTRACT

A composition includes a solvent, a catalyst, a polysiloxane including methyl and phenyl pendant groups, and a crosslinker comprising at least one of a phenylene disilyl group and para-disilyl phenylene group. Exemplary crosslinkers include bis silyl benzene, bis alkoxysilane, 1,3 bistriethoxysilyl benzene, and 1,4 bistriethoxysilyl benzene 2,6-bis(triethoxysilyl)-naphthalene, 9,10-bis(triethoxysilyl)-anthracene, and 1,6-bis(trimethoxysilyl)-pyrene.

### CROSS-REFERENCE TO RELATED APPLICATION

This application claims priority to U.S. Provisional Patent Application Ser. No. 62/307,958, filed Mar. 14, 2016, the disclosure of which is hereby expressly incorporated by reference herein in its entirety.

### TECHNICAL FIELD

The present disclosure relates generally to polysiloxane formulations and coatings made from those compositions, and more particularly to polysiloxane formulations and coatings for use in optoelectronic devices and applications.

### BACKGROUND

Polysiloxane coatings for electronic, optoelectronic, and display devices are disclosed, for example, in U.S. Pat. No. 8,901,268, entitled, COMPOSITIONS, LAYERS AND FILMS FOR OPTOELECTRONIC DEVICES, METHODS OF PRODUCTION AND USES THEREOF, the disclosures of which are hereby incorporated by reference in their entirety.

In a typical polysiloxane coating, the coating is formed from a hydrolysis and condensation reaction of silicon-based compounds, such as siloxane monomers or oligomers, often with the use of a condensation catalyst. Typical thick film dielectrics used for displays suffer from history-dependent shrinkage. That is, when the films undergo multiple thermal cycles, the material lacks dimensional stability and can undergo structural change adversely affecting the material in its application. This is particularly relevant in large area manufacturing in which the material has to maintain dimensional stability across the area during process thermal cycles.

Improvements in the foregoing are desired.

### SUMMARY

The present disclosure provides polysiloxane formulations including one or more solvents and one or more silicon-based compounds. The present disclosure further provides coatings formed from such formulations.

In one exemplary embodiment, a composition is provided. The composition includes a solvent, a catalyst, a polysiloxane including methyl and phenyl pendant groups, and a crosslinker comprising at least one of a phenylene disilyl group and para-disilyl phenylene group. In a more particular embodiment, the crosslinker is selected from the group consisting of 1,4 bistriethoxysilyl benzene and 1,3 bistriethoxysilyl benzene, 2,6-bis(triethoxysilyl)-naphthalene, 9,10-bis(triethoxysilyl)-anthracene, and 1,6-bis(trimethoxysilyl)-pyrene.

In a more particular embodiment of any of the above embodiments, a ratio of phenyl pendant groups to methyl pendant groups is from greater than 1:1 to less than 10:1. In another more particular embodiment, the ratio of phenyl pendant groups to methyl pendant groups is from 2:1 to 4:1. In another more particular embodiment, the ratio of phenyl pendant groups to methyl pendant groups of the composition between 1:1 and 3:1. In another more particular embodiment, the ratio of phenyl pendant groups to methyl pendant groups of the composition is 2:1 or greater. In another more particular embodiment, the ratio of phenyl pendant groups to methyl pendant groups of the composition is 3:1 or greater.

In one more particular embodiment of any of the above embodiments, the composition comprises from about 0.15 wt. % to about 75 wt. % of the crosslinker, based on a total weight of the composition.

In a more particular embodiment of any of the above embodiments, the catalyst is a heat-activated catalyst. In another more particular embodiment of any of the above embodiments, the composition further comprises at least one of a surfactant or an adhesion promoter.

In a more particular embodiment of any of the above embodiments, the composition is a crosslinkable composition.

In one exemplary embodiment, a crosslinked film is provided. The crosslinked film is formed from a composition according to any of the above embodiments. In a more particular embodiment, the crosslinker forms bonds between silicon groups of the polysiloxane.

In one exemplary embodiment, a device having a surface is provided. The surface includes a crosslinked film according to any of the above embodiments, or includes a crosslinked film formed from any of the above embodiments. In a more particular embodiment of any of the above embodiments, the device is selected from the group consisting of a transistor, a light-emitting diode, a color filter, a photovoltaic cell, a flat-panel display, a curved display, a touch-screen display, an x-ray detector, an active or passive matrix OLED display, an active matrix think film liquid crystal display, an electrophoretic display, a CMOS image sensor, and combinations thereof. In a more particular embodiment of any of the above embodiments, the crosslinked film forms a passivation layer, a planarization layer, a barrier layer, or a combination thereof.

In one exemplary embodiment, a method of forming a coating on a substrate is provided. The method includes providing a composition according to any of the above embodiments and depositing the composition on the substrate.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 is related to Example 1 and shows the volume change after cooling data of the different polysiloxane compounds based on aryl to methyl ratio in the quenched state and undergoing subsequent process cycling.

FIG. 2 is related to Example 1 and shows a comparison of the room temperature volume change after cooling data of the compounds based on aryl to methyl ratio in the equilibrated state and undergoing subsequent process cycling.

FIG. 3A is related to Example 2 and shows the modeled Coefficient of Thermal Expansion (CTE) data of a compound that is uncrosslinked, rigidized/fused ladder system and has a 3:1 aryl to methyl ratio in the quenched state and during subsequent process cycling.

FIG. 3B is related to Examples 2 and 4 and shows the modeled CTE data of a compound that is crosslinked, rigidized/fused ladder and has a 1:1 aryl to methyl ratio in the quenched state and during subsequent process cycling.

FIG. 3C is related to Examples 2 and 4 and shows the modeled CTE trends of a compound that is uncrosslinked, rigidized/fused ladder system and has a 1:1 aryl to methyl ratio in the quenched state and during subsequent process cycling.

FIG. 3D is related to Example 2 and shows the modeled CTE trends of a rigidized/fused ladder compound that is crosslinked and has a 3:1 aryl to methyl ratio in the quenched state and during subsequent process cycling.

FIG. 4A is related to Example 2 and shows the modeled CTE data for a compound that is uncrosslinked, rigidized/fused ladder system and has 3:1 aryl to methyl ratio in the equilibrated state and during subsequent process cycling.

FIG. 4B is related to Example 2 and shows the modeled CTE data for a compound that is crosslinked, rigidized/fused ladder and has 1:1 aryl to methyl ratio in the equilibrated state and during subsequent process cycling.

FIG. 4C is related to Example 2 and shows the modeled CTE data for a compound that is uncrosslinked, rigidized/fused ladder and has 1:1 aryl to methyl ratio in the equilibrated state and during subsequent process cycling.

FIG. 4D is related to Examples 2 and 4 and shows the modeled CTE trend for a compound that is crosslinked, rigidized/fused ladder and has a 3:1 aryl to methyl ratio in the equilibrated state and during subsequent process cycling.

FIG. 5 is related to Example 3 and shows the modeled volume change after cooling data for the compounds in the quenched state and during subsequent process cycling.

FIG. 6 is related to Examples 3 and 4 and shows modeled volume change after cooling data for the compounds that have crosslinking, fused ladders, or random ladders in an equilibrated state during subsequent process cycling.

FIG. 7 is related to Example 4 and shows the modeled CTE data for a compound that has a quenched uncrosslinked randomized ladder structure with 1:1 aryl to methyl ratio and during subsequent process cycling.

FIG. 8 is related to Example 4 and shows the modeled volume change after cooling data for compounds that have crosslinking, fused ladders, or a randomized ladder structure in the quenched state and during subsequent process cycling.

FIG. 9 is related to Example 5 and shows the modeled volume change after cooling data for compounds that have fused ladders, fused ladders with block substitution, or a randomized ladder structure in a quenched state and during subsequent process cycling.

FIG. 10A is related to Example 5 and shows the modeled volume change after cooling data over 5 thermal cycles for a compound that has a fused ladder with block substitution in the equilibrated state and during subsequent process cycling.

FIG. 10B is related to Example 5 and shows modeled volume change after cooling data for 5 thermal cycles for a compound that has a fused ladder structure in the equilibrated state and during subsequent process cycling.

FIG. 10C is related to Example 5 and shows modeled volume change after cooling data for 5 thermal cycles for a compound that has a randomized ladder structure in the equilibrated state and during subsequent process cycling.

FIG. 11 is related to Examples 1-5 and shows the process cycling used as an example of molecular modeling process cycling.

FIG. 12 is related to Examples 1-5 and shows the temperature progression for the process cycling for the quenched case for molecular modeling.

FIG. 13 is related to Examples 1-5 and shows the temperature progression for the process cycling for the equilibrated case for molecular modeling.

Corresponding reference characters indicate corresponding parts throughout the several views. The exemplifications set out herein are provided to illustrate certain exemplary embodiments and such exemplifications are not to be construed as limiting the scope in any manner.

### DETAILED DESCRIPTION

I. Polysiloxane Formulation

In one exemplary embodiment, the polysiloxane formulation includes one or more solvents and one or more silicon-based compounds. In some exemplary embodiments, the formulation further includes one or more catalysts. In some exemplary embodiments, the formulation further includes one or more surfactants. In some exemplary embodiments, the formulation further includes one or more additional additives, such as adhesion promoters, plasticizers, organic acids, and monofunctional silanes.

a. Solvent

The formulation includes one or more solvents. Exemplary solvents include suitable pure organic molecules or mixtures thereof that are volatilized at a desired temperature and/or easily solvate the components discussed herein. The solvents may also comprise suitable pure polar and non-polar compounds or mixtures thereof. As used herein, the term “pure” means a component that has a constant composition. For example, pure water is composed solely of H₂O. As used herein, the term “mixture” means a component that is not pure, including salt water. As used herein, the term “polar” means that characteristic of a molecule or compound that creates an unequal charge, partial charge or spontaneous charge distribution at one point of or along the molecule or compound. As used herein, the term “non-polar” means that characteristic of a molecule or compound that creates an equal charge, partial charge or spontaneous charge distribution at one point of or along the molecule or compound.

Exemplary solvents include solvents that can, alone or in combination, modify the viscosity, intermolecular forces and surface energy of the solution in order to, in some cases, improve the gap-filling and planarization properties of the composition. It should be understood, however, that suitable solvents may also include solvents that influence the profile of the composition in other ways, such as by influencing the crosslinking efficiency, influencing the thermal stability, influencing the viscosity, and/or influencing the adhesion of the resulting layer or film to other layers, substrates or surfaces.

Exemplary solvents also include solvents that are not part of the hydrocarbon solvent family of compounds, such as ketones, including acetone, diethyl ketone, methyl ethyl ketone and the like, alcohols, esters, ethers and amines. Additional exemplary solvents include ethyl lactate, propylene glycol propylether (PGPE), propylene glycol monomethyl ether acetate (PGMEA) or a combination thereof. In one exemplary embodiment, the solvent comprises propylene glycol monomethyl ether acetate.

In one exemplary embodiment, formulation comprises as little as 20 wt. %, 30 wt. %, 40 wt. %, 50 wt. %, 55 wt. %, 60 wt. %, as great as 80 wt. %, 85 wt. %, 90 wt. %, or 99 wt. % of the one or more solvents, or within any range defined between any two of the foregoing values, such as 50 wt. % to 99 wt. %, 55 wt. % to 90 wt. %, or 65 wt. % to 85 wt. %. The determination of the appropriate amount of solvent to add to composition depends on a number of factors, including: a) thicknesses of the desired layers or films, b) desired concentration and molecular weight of the solids in the composition, c) application technique of the composition and/or d) spin speeds, when spin-coating techniques are utilized. In addition, the higher the solid concentration (or the resin or polymer) is in the formulation, the higher the viscosity. Hence, the solid content may be increased (or the solvent amount reduced) to increase the viscosity as desired for a specific coating application technique. In addition, the viscous formulation or formulation with higher solid content will typically provide a thicker film thickness such as greater than 2 μm.

The solvents used herein may comprise any suitable impurity level. In some embodiments, the solvents utilized have a relatively low level of impurities, such as less than about 1 ppm, less than about 100 ppb, less than about 10 ppb, less than about 1 ppb, less than about 100 ppt, less than about 10 ppt and in some cases, less than about 1 ppt. These solvents may be purchased having impurity levels that are appropriate for use in these contemplated applications or may need to be further purified to remove additional impurities and to reach the less than about 10 ppb, less than about 1 ppb, less than about 100 ppt or lower levels that suitable and/or desired.

b. Silicon-Based Compounds

The formulation includes one or more silicon-based compounds that can be crosslinked to form the polysiloxane. Exemplary silicon-based compounds comprise siloxane, silsesquioxane, polysiloxane, or polysilsesquioxane, such as methylsiloxane, methylsilsesquioxane, phenylsiloxane, phenylsilsesquioxane, methylphenylsiloxane, methylphenylsilsesquioxane, dimethylsiloxane, diphenylsiloxane, methylphenylsiloxane, polyphenylsilsesquioxane, polyphenylsiloxane, polymethylphenylsiloxane, polymethylphenylsilsesquioxane, polymethylsiloxane, polymethylsilsesquioxane, and combinations thereof. In some embodiments, the at least one silicon-based compound comprises polyphenylsilsesquioxane, polyphenylsiloxane, phenylsiloxane, phenyl silsesquioxane, methylphenylsiloxane, methylphenylsilsesquioxane, polymethylphenylsiloxane, polymethylphenylsilsesquioxane, polymethylsiloxane, polymethylsilsesquioxane or a combination thereof.

The silicon-based compound includes organic substituents, such as alkyl and aryl groups. Exemplary alkyl groups include methyl and ethyl. Exemplary aryl groups include phenyl. In some embodiments, a ratio of aryl groups to alkyl groups in the silicon-based compound is as little as greater than 1:1, 1.5:1, 2:1, as great as 3:1, 4:1, 5:1, 6:1, 7:1, 8:1, 9:1, 10:1, less than 10:1, or between any range defined between any two of the foregoing values, such as from greater than 1:1 to less than 5:1, from 2:1 to 4:1, or 2.5:1 to less than 5:1.

Without wishing to be held to any particular theory, it is believed that increasing the ratio of aryl groups to alkyl groups increases the organic to organic group cohesion resulting in a polysiloxane that is less flexible.

Some contemplated silicon-based compounds include compositions formed from hydrolysis-condensation reactions of at least one reactant having the formula:

R¹ₓSi(OR²)_{y}

where R¹ is an alkyl, alkenyl, aryl, or aralkyl group, and x is an integer between 0 and 2, and where R² is a alkyl group or acyl group and y is an integer between 1 and 4. Materials also contemplated include silsesquioxane polymers of the general formula: (C₆H₅SiO_{1.5})ₓ where x is an integer greater than about 4.

In some exemplary embodiments, the silicon-based compound includes one or more polysiloxane resins, such as the Glass Resin polysiloxane resins available from Techneglas Technical Products, Perrysburg, Ohio. In one exemplary embodiment, polysiloxane resins are silicon-based oligomers formed from a limited hydrolysis and condensation reaction of one or more silicon-based monomers. Exemplary suitable silicon-based monomers include organoalkoxysilanes having a Si—C bond, such as methyltrimethoxysilane (MTMOS), methyltriethoxysilane (MTEOS), dimethyldiethoxysilane (DMDEOS), phenyl triethoxysilane (PTEOS), dimethyldimethoxysilane and phenyltrimethoxysilane. Other suitable silicon-based monomers lack an Si—C bond, such as tetraethylorthosilicate (TEOS). Exemplary resin materials include glass resins derived from organoalkoxysilanes such as methylsiloxane, dimethylsiloxane, phenylsiloxane, methylphenylsiloxane, tetraethoxysilane, and mixtures thereof.

In one exemplary embodiment, the polysiloxane resins have a structure selected from the group consisting of a linear structure, a cyclic structure, a cage-type structure, a ladder-type structure, and a partial-ladder/partial-cage type structure. In a more particular embodiment, the polysiloxane resins have a partial-ladder/partial-cage type structure.

In some exemplary embodiments, the polysiloxane resins include one or more alkyl groups and/or one or more aryl groups. Exemplary polysiloxane resins containing alkyl groups include methylsiloxane and dimethylsiloxane. Exemplary polysiloxane resins containing aryl groups include phenylsiloxane. Exemplary polysiloxane resins containing both alkyl and aryl groups include methylphenylsiloxane.

In one exemplary embodiment, each polysiloxane resin has a weight average molecular weight as little as 900 atomic mass unit (AMU), 950 AMU, 1000 AMU, 1100 AMU, 1150 AMU, as great as 2000 AMU, 3000 AMU, 4000 AMU, 5000 AMU, 10,000 AMU , or within any range defined between any two of the foregoing values, such as 900 AMU to 10,000 AMU, 1000 AMU to 10,000 AMU, or 900 AMU to 5000 AMU. In a more particular embodiment, the polysiloxane resin include a first polysiloxane resin containing alkyl groups such as methylsiloxane and/or dimethylsiloxane and a second polysiloxane resin containing aryl groups such as phenylsiloxane. In one embodiment, the first polysiloxane resin further contains aryl groups such as phenylsiloxane. In an even more particular embodiment, the first polysiloxane resin has a weight average molecular weight as little as 1000 atomic mass unit (AMU), 2000 AMU, 2200 AMU, 3000 AMU, 3800 AMU, 4000 AMU, as great as 4500 AMU, 4800 AMU, 5000 AMU, 7500 AMU, 10,000 AMU or within any range defined between any two of the foregoing values, such as 1000 AMU to 10,000 AMU, 2000 AMU to 5000 AMU, or 3800 AMU to 4800 AMU and the second polysiloxane resin has a weight average molecular weight as little as 900 atomic mass unit (AMU), 950 AMU, 1000 AMU, as great as 1150 AMU, 2000 AMU, 2500 AMU, 5000 AMU or within any range defined between any two of the foregoing values, such as 900 AMU to 5000 AMU, 900 AMU to 2000 AMU, or 950 AMU to 1150 AMU.

In one exemplary embodiment, the formulation comprises as little as 1 wt. %, 2 wt. %, 5 wt. %, 10 wt. %, 15 wt. %, 20 wt. %, 25 wt. %, 30 wt. %, 40 wt. %, as great as 50 wt. %, 60 wt. %, 70 wt. %, 75 wt. %, or 80 wt. % of the one or more silicon-based compounds, or within any range defined between any two of the foregoing values, such as 01 wt. % to 80 wt. %, 5 wt. % to 50 wt. %, or 20 wt. % to 35 wt. %.

c. Catalysts

In some exemplary embodiments, the formulation includes one or more catalysts. In some embodiments, the catalyst is a heat-activated catalyst. A heat-activated catalyst, as used herein, refers to a catalyst that is activated at or above a particular temperature, such as an elevated temperature. For example, at one temperature (such as room temperature) the composition maintains a low molecular weight, thus enabling good planarization ability over a surface. When the temperature is elevated (such as to greater than 50° C.), the heat-activated catalyst catalyzes a condensation reaction between two Si—OH functional groups, which results in a more dense structure and, in some cases, improved performance overall. Suitable condensation catalysts comprise those catalysts that can aid in maintaining a stable silicate solution. Exemplary metal-ion-free catalysts may comprise onium compounds and nucleophiles, such as an ammonium compound (such as quaternary ammonium salts), an amine, a phosphonium compound or a phosphine compound.

In some embodiments, the catalyst is relatively molecularly “small” or is a catalyst that produces relatively small cations, such as quaternary ammonium salts. In some embodiments, the one or more catalysts is selected from tetramethylammonium acetate (TMAA), tetramethylammonium hydroxide (TMAH), tetrabutylammonium acetate (TBAA), cetyltrimethylammonium acetate (CTAA), tetramethylammonium nitrate (TMAN), other ammonium-based catalysts, amine-based and/or amine-generating catalysts, and combinations thereof. Other exemplary catalysts include (2-hydroxyethyl)trimethylammonium chloride, (2-hydroxyethyl)trimethylammonium hydroxide, (2-hydroxyethyl)trimethylammonium acetate, (2-hydroxyethyl)trimethylammonium formate, (2-hydroxyethyl)trimethylammonium nitrate, (2-hydroxyethyl)trimethylammonium benzoate, tetramethylammonium formate and combinations thereof. Other exemplary catalysts include (carboxymethyl)trimethylammonium chloride, (carboxymethyl)trimethylammonium hydroxide, (carboxymethyl)trimethyl-ammonium formate and (carboxymethyl)trimethylammonium acetate.

In one exemplary embodiment, the formulation comprises as little as 0.001 wt. %, 0.004 wt. %, 0.01 wt. %, 0. 1 wt. %, 0.3 wt. %, as great as 0.5 wt. %, 1 wt. %, 2 wt. %, 5 wt. %, or 10 wt. % of the one or more catalysts, or within any range defined between any two of the foregoing values, such as 0.1 wt. % to 10 wt. % or 1 wt. % to 2 wt. %.

In some exemplary embodiments, the one or more catalysts comprise TMAN. TMAN may be provided by either dissolving TMAN in water or in an organic solvent such as ethanol, propylene glycol propyl ether (PGPE), or by converting TMAA or TMAH to TMAN by using nitric acid.

d. Surfactant

In some exemplary embodiments, the formulation includes one or more surfactants. Surfactants may be added to lower surface tension. As used herein, the term “surfactant” means any compound that reduces the surface tension when dissolved in H₂O or other liquids, or which reduces interfacial tension between two liquids, or between a liquid and a solid. Contemplated surfactants may include at least one anionic surfactant, cationic surfactant, non-ionic surfactant, Zwitterionic surfactant or a combination thereof. The surfactant may be dissolved directly into the composition or may be added with one of the compositions components (the at least one silicon-based compound, the at least one catalyst, the at least one solvent) before forming the final composition. Contemplated surfactants may include: polyether modified polydimethylsiloxanes such as BYK 307 (polyether modified poly-dimethyl-siloxane, BYK-Chemie), sulfonates such as dodecylbenzene sulfonate, tetrapropylenebenzene sulfonate, dodecylbenzene sulfonate, a fluorinated anionic surfactant such as Fluorad FC-93, and L-18691 (3M), fluorinated nonionic surfactants such as FC-4430 (3M), FC-4432 (3M), and L-18242 (3M), quaternary amines, such as dodecyltrimethyl-ammonium bromide or cetyltrimethylammonium bromide, alkyl phenoxy polyethylene oxide alcohols, alkyl phenoxy polyglycidols, acetylinic alcohols, polyglycol ethers such as Tergitol TMN-6 (Dow) and Tergitol minifoam 2× (Dow), polyoxyethylene fatty ethers such as Brij-30 (Aldrich), Brij-35 (Aldrich), Brij-58 (Aldrich), Brij-72 (Aldrich), Brij-76 (Aldrich), Brij-78 (Aldrich), Brij-98 (Aldrich), and Brij-700 (Aldrich), betaines, sulfobetaines, such as cocoamidopropyl betaine, and synthetic phospholipids, such as dioctanoylphosphatidylcholine and lecithin and combinations thereof.

In one exemplary embodiment, the formulation comprises as little as 0.001 wt. %, 0.005 wt. %, 0.01 wt. %, 0.05 wt. %, 0.1 wt. %, 0.25 wt. %, as great as 0.5 wt. %, 1 wt. %, 2 wt. %, or 5 wt. % of the one or more surfactants, or within any range defined between any two of the foregoing values, such as 0.001 wt. % to 5 wt. % or 0.001 wt. % to 1 wt. %, or 0.05 to 0.5 wt. %. The determination of the appropriate amount of a composition-modifying constituent to add to the composition depends on a number of factors, including: a) minimizing defects in the film, and/or b) balancing the film between good adhesion and desirable film properties.

e. Crosslinker

In some exemplary embodiments, the formulation includes one or more crosslinkers. Crosslinkers form bonds between the silicon-based compound. In some exemplary embodiments, the crosslinker maintains a high degree of aryl to aryl interaction in the formed coating, and additionally adds a physical covalent bond between chains to further stabilize movement of the attached chains. Without wishing to be held to any particular theory, it is believed that, from a visco-elastic viewpoint, the crosslinker helps to strengthen the elastic part of the response as well as add to the plastic response from the aryl to aryl interaction. Suitable crosslinkers may be incorporated into the formulation incorporate without phase separation. Exemplary crosslinkers include compounds having an aryl disilyl, such as 1,3 bistriethoxysilyl benzene, 1,4 bistriethoxysilyl benzene, 2,6-bis(triethoxysilyl)-naphthalene, 9,10-bis(triethoxysilyl)-anthracene, 1,6-bis(trimethoxysilyl)-pyrene. In one exemplary embodiment, the crosslinker includes an aryl organic functional group having at least two hydrolyzable siloxy units, such as alkyoxysilanes or hydrosilanes, that may be hydrolyzed to silanols for reaction with other silanols within the silicate.

In one exemplary embodiment, the formulation comprises as little as 0.15 wt. %, 0.25 wt. %, 0.5 wt. %, 1 wt. %, 2 wt. %, 5 wt. %, 10 wt. %, as great as 20 wt. %, 25 wt. %, 30 wt. %, 40 wt. %, 50 wt. %, or 75 wt. % of the crosslinker, or within any range defined between any two of the foregoing values, such as 0.15 wt. % to 75 wt. %, 0.15 wt. % to 1 wt. %, 1 wt. % to 10 wt. %, or 5 wt. % to 75 wt. %.

f. Other Additives

In some exemplary embodiments, the formulation may include one or more additional additives, such as adhesion promoters, endcapping agents, and organic acids.

In one exemplary embodiment, the formulation includes one or more adhesion promoters in order to influence the ability of the layer, coating or film to adhere to surrounding substrates, layers, coatings, films and/or surfaces. The adhesion promoter may be at least one of: a) thermally stable after heat treatment, such as baking, at temperatures generally used for optoelectronic component manufacture, and/or b) promotes electrostatic and coulombic interactions between layers of materials, as well as promoting understood Van derWaals interactions in some embodiments. Exemplary adhesion promoters include aminopropyl triethoxysilane (APTEOS) and salts of APTEOS, vinyltriethoxy silane (VTEOS), glycidoxypropyltrimethoxy silane (GLYMO), and methacryloxypropyltriethoxy silane (MPTEOS). Other exemplary adhesion promoters include 3-(triethoxysilyl)propylsuccininc anhydride, dimethyldihydroxy silane, methylphenyl dihydroxysilane or combinations thereof. In one exemplary embodiment, the formulation comprises as little as 0.001 wt. %, 0.01 wt. %, 0.1 wt. %, 0.26 wt. % as great as 1 wt. %, 2.6 wt. %, 5 wt. %, 10 wt. %, 20 wt. % of the one or more adhesion promoters, or within any range defined between any two of the foregoing values, such as 0.001 wt. % to 20 wt. % or 0.26 wt. % to 2.6 wt. %.

In one exemplary embodiment, the formulation includes one or more endcapping agents such as monofunctional silanes that include a single reactive functionality that is capable of reacting with silanol groups on polysiloxane molecules. Exemplary endcapping agents include trialkylsilanes such as trimethylethoxy silane, triethylmethoxy silane, trimethylacetoxy silane, trimethylsilane. In one exemplary embodiment, the formulation comprises as little as 0.1%, 0.5%, 1%, 2%, as great as 5%, 10%, 15%, 20%, or 25% of the one or more endcapping agents as a percentage of total moles of polysiloxane, or within any range defined between any two of the foregoing values, such as 2% to 20% or 5% to 10%.

In one exemplary embodiment, the formulation includes one or more organic acids. In some embodiments, the organic acid additives are volatile or decompose at high temperatures and help stabilize the formulation. Exemplary organic acids include p-toluenesulfonic acid, citric acid, formic acid, acetic acid, and trifluoroacetic acid. In one exemplary embodiment, the formulation comprises as little as 0. 1 wt. %, 0.5 wt. %, 1 wt. %, 2 wt. %, as great as 5 wt. %, 10 wt. %, 15 wt. %, 20 wt. %, or 25 wt. % of the one or more organic acids, or within any range defined between any two of the foregoing values, such as 2 wt. % to 20 wt. % or 5 wt. % to 10 wt. %.

II. Polysiloxane Coating

In some exemplary embodiments, the polysiloxane formulation forms a polysiloxane coating on a surface located in or on an electronic, optoelectronic, or display device.

In some exemplary embodiments, the polysiloxane formulation forms a light-transmissive coating. In a more particular embodiment, the light-transmissive coating has a transmittance to light in the visible optical wavelength range from 400 to 1000 nm. In some embodiments, the optical transmittance is as high as 80%, 85%, 90%, 95%, 97%, 98%, 99%, or higher, or within any range defined between any two of the foregoing values.

In some exemplary embodiments, one or polymer resins are selected to provide a desired refractive index. In one exemplary embodiment, the relative molar percentage of a resin having a relatively low refractive index, such as 100% methyltriethoxysilane resin, is relatively high to produce a polysiloxane coating having a relatively low refractive index. In another exemplary embodiment, the relative molar percentage of a resin having a relatively high refractive index, such as 100% phenyl triethoxysilane, is relatively high to produce a polysiloxane coating having a relatively high refractive index. In another exemplary embodiment, the relative molar proportions of a first resin having a relatively high refractive index and a second resin having a relatively low refractive index are selected to produce a polysiloxane coating having a desired refractive index between the refractive index of the first and second resins.

In some exemplary embodiments, the polysiloxane formulation forms a coating having a refractive index that is as little as less than 1.4, 1.4, 1.45, as great as 1.5, 1.55, 1.56, 1.6, or within any range defined between any two of the foregoing values, such as from less than 1.4 to 1.6 or from 1.4 to 1.56.

Exemplary devices to which coatings of the present disclosure may be provided include CMOS Image Sensors, transistors, light-emitting diodes, color filters, photovoltaic cells, flat-panel displays, curved displays, touch-screen displays, x-ray detectors, active or passive matrix OLED displays, active matrix thin film liquid crystal displays, electrophoretic displays, and combinations thereof.

In some exemplary embodiments, the polysiloxane coating forms a passivation layer, a barrier layer, a planarization layer, or a combination thereof.

In some exemplary embodiments, the polysiloxane coating has a thickness as little as 0.1 μm, 0.3 μm, 0.5 μm, 1 μm, 1.5 μm, as great as 2 μm, 2.5 μm, 3 μm, 3.5 μm, 4 μm, or greater, or within any range defined between any two of the foregoing values.

In some exemplary embodiments, the polysiloxane coating is formed by applying the formulation to a surface and polymerizing the formulation. In one exemplary embodiments, a baking step is provided to remove at least part or all of the solvent. In some embodiments, the baking step is as short as 1 minute, 5 minutes, 10 minutes, 15 minutes, as long as 20 minutes, 30 minutes, 45 minutes, 60 minutes, or longer, at a temperature as low as 100° C., 200° C., 220° C., as high as 250° C., 275° C., 300° C., 320° C., 350° C., or higher. In one exemplary embodiment, a curing step is provided to polymerize the at least one silicon-based material such as by activating a heat-activated catalyst. In some embodiments, the curing step is as short as 10 minutes, 15 minutes, 20 minutes, as long as 30 minutes, 45 minutes, 60 minutes, or longer, at a temperature as low as 250° C., 275° C., 300° C., as high as 320° C., 350° C., 375° C., 380° C., 400° C. or higher.

In some exemplary embodiments, the polysiloxane coating is resistant to multiple heating steps, such as curing or deposition of additional coatings or layers on the formed polysiloxane coating.

### EXAMPLES

### Example 1

### Effect of Aryl to Methyl Ratio on Polymer Structure

Samples of polysiloxane compounds with a 1:1 and 3:1 phenyl to methyl group ratio underwent molecular modeling to study and predict the compositional effects of different aryl to alkyl ratios on the performance properties of the materials.

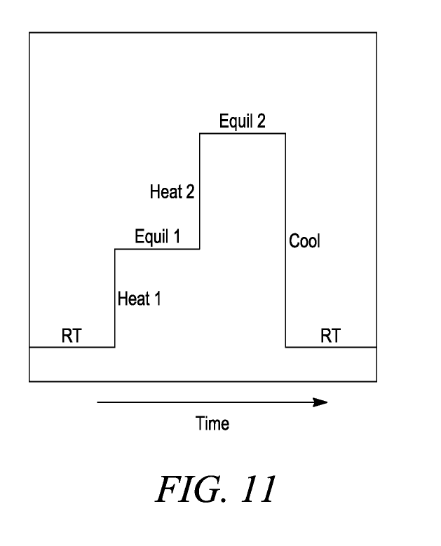

Molecular modeling is a flexible platform to study and predict compositional effects on the performance properties of materials, and previous performance issues include the impact of process cycles as a source of failure. In these cases, as shown in FIG. 11, the process cycle that the samples underwent was represented by combinations of molecular dynamic equilibration steps and stress-based molecular models at specific flow temperatures used in the process to mimic flow stages. In FIG. 11, dynamic equilibration steps are represented by thermal hold steps such as Equil 1 and Equil 2, and stress-based molecular modeling steps are represented by steps such as heat 1 and heat 2.

The unit cell used for this study was examined for changes in dimensions to see whether there was a net change that might be a reason to expect a residual stress development from the process.

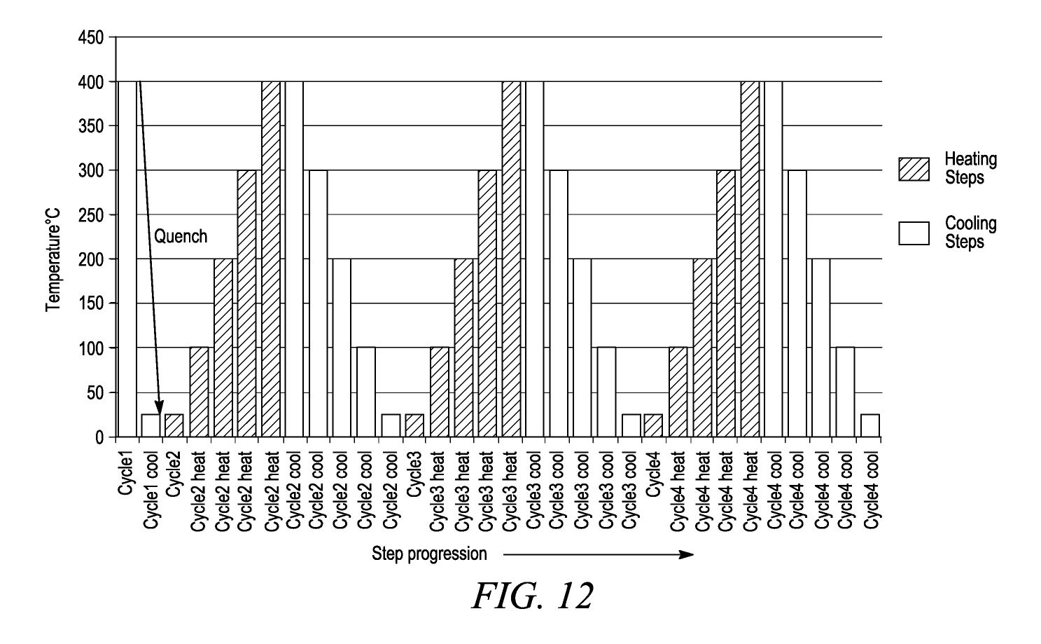

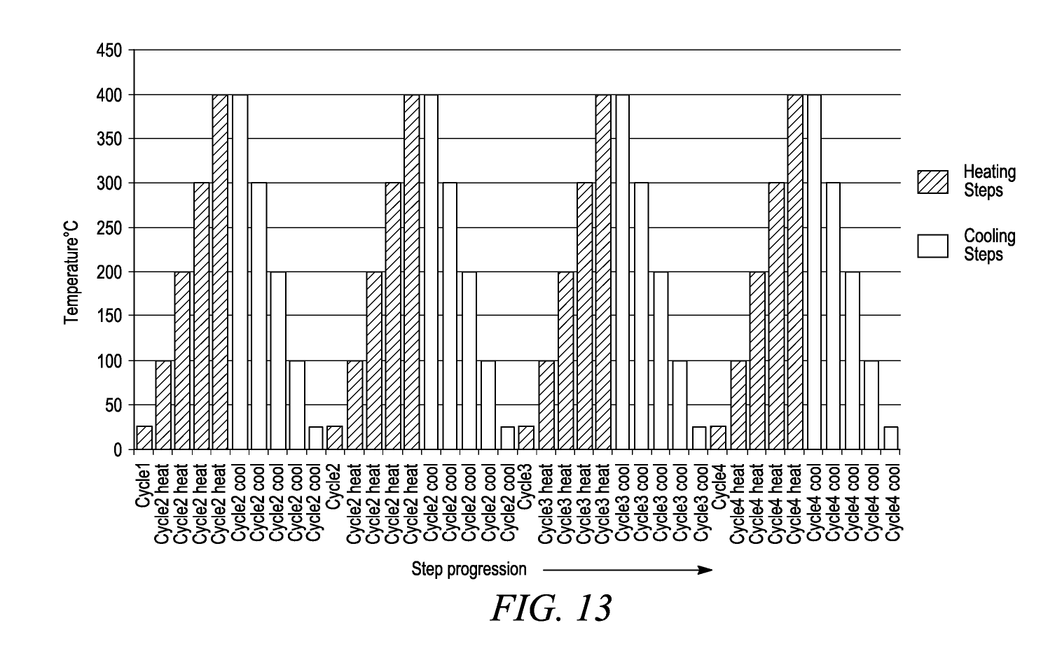

Thermal coefficients of expansion were modeled using thermal cycling with the molecular modeling program “Discover” used within the Materials Studio graphical interface from Biovia, San Diego, Calif. as described in further detail below. The samples would be quenched at different rates after curing and then undergo subsequent thermal cycling as shown in FIGS. 12 and 13 described below. One case involved the assumption that the material was quenched after curing or rapidly cooled (quenched case, FIG. 12), and the second case involves a gradual cool down after curing (equilibrated case, FIG. 13).

The initial conditions for the samples were developed depending upon a cooling history from the cure condition assumed. The equilibrated cool (from cure) was created by an extended 100ps equilibration at room temperature. The quenched case (from an assumed curing temperature of 400° C.) was created by using an initial room temperature equilibrated case, which was then equilibrated at 400° C. for 10 ps at constant content (N), pressure (P), and temperature (T) (NPT) followed by an immediate drop to room temperature for 10 ps at constant content (N), volume (V), and temperature (T) (NVT), constant volume. The assumption for the NVT quench step is that there is inadequate time for relaxation, so no volume change is assumed. The rest of the steps for both cases (equilibrated and quenched) use a relatively gradual temperature change (compared to the quench step), with temperature changes in 100° C. steps and each step being equilibrated for 10 ps as shown in FIGS. 12 and 13. The equilibrated case utilizes a relatively gradual change in temperature, with temperature changes in 100° C. steps with each step being equilibrated for 10 ps.

Table 1 provides the exemplary formulations that were modeled in the Examples.

TABLE 1
Formulation properties

| Formulation Number | Phenyl to Methyl Ratio | Crosslinked? |
|---|---|---|
| Formulation 1 | 1:1 | No |
| Formulation 2 | 3:1 | No |
| Formulation 3 | 1:1 | Yes |
| Formulation 4 | 3:1 | Yes |

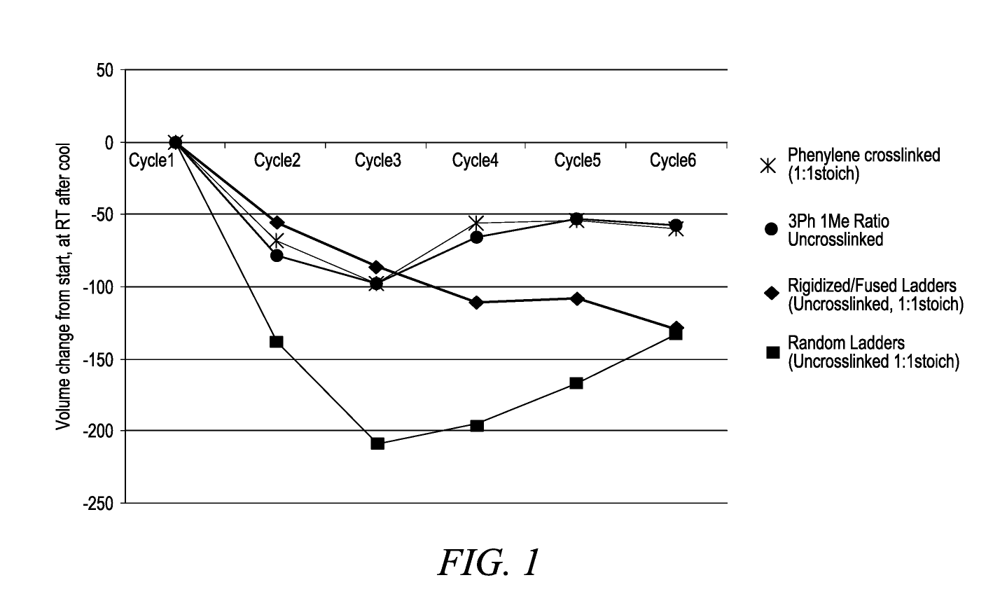

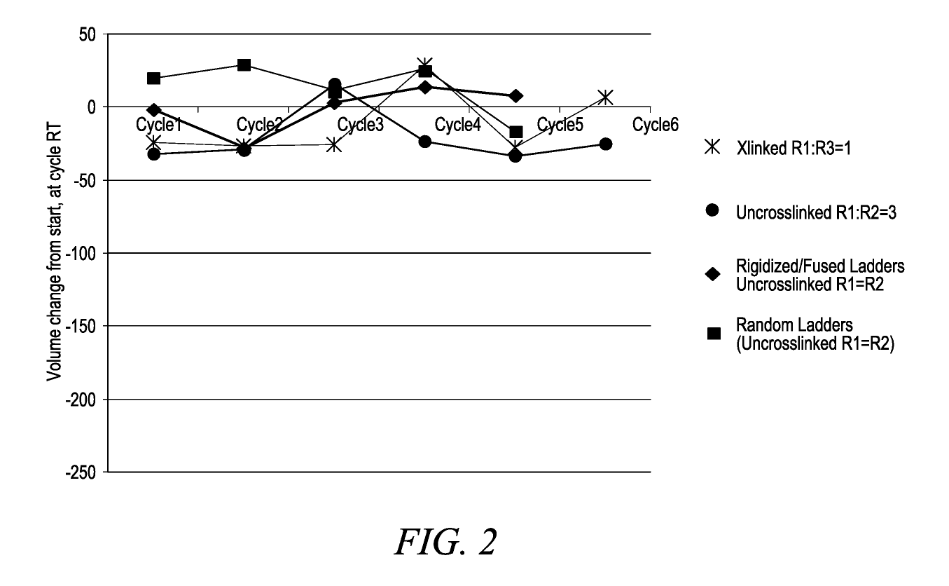

FIG. 1 provides a comparison of the room temperature volume change after cooling data of different polysiloxane compounds based on phenyl to methyl ratio for the modeled quenched case. FIG. 2 provides the comparison of the room temperature volume change after cooling data of the compounds based on the phenyl to methyl ratio for the modeled equilibrated case.

As shown in FIG. 1, in the quenched case, Formulation 2 offered substantially greater stability than Formulation 1. Formulation 2 also offered substantially the same stability over multiple thermal cycles as the Formulation 3 indicating that the aryl to aryl interaction stabilizes the volume changes. In other words, the volume change at room temperature after cooling is minimized with a higher aryl to methyl ratio.

As shown in FIG. 2, in the equilibrated case, polysiloxane compounds with a 3:1 aryl to methyl ratio (Formulations 2 and 4) had a volume change that fluctuated between the extents found in the previous structures with a 1:1 aryl to methyl ratio (Formulation 1 and Formulation 3) That is, when properly equilibrated, less volume change fluctuation is expected during cycling.

Comparing the volume changes between different cooling conditions, Formulation 2 behaved similarly to the crosslinked phenylene case (FIG. 1) in the quenched case. Comparing Formulation 1 to Formulations 2 and 4 demonstrates the impact of the aryl-aryl non bond interaction. That is, in high enough compositions, the non-bonds are as stabilizing as physical crosslink. Effective crosslinking will be described in further detail below.

For the quenched case, increasing the phenyl to methyl ratio from 1:1 to 3:1 seems to have stabilized the quenched state shrinkage. It has done so in a similar manner as the cross-linked 1:1 phenyl to methyl compound indicating that the phenyl to phenyl interaction stabilizing the volume changes.

The equilibrated case has a lower volume change as compared to the quenched case as shown in FIG. 2 in comparison with FIG. 1. The equilibrated case shows that Formulations 2 and 4 show a marked volume stability over the quenched case, but no significant difference to the other equilibrated structures.

In both the quenched and equilibrated case, the model indicated that a Formulation 2 had increased stability compared to Formulations 1 and 3 indicating that a higher phenyl to methyl ratio led to increased stability and lower volume change after undergoing process cycling.

### Example 2

### Effect of Phenyl to Methyl Ratio on CTE of Polymer

Samples of the polysiloxane compounds with different phenyl to methyl ratios underwent thermal cycling of Example 1 to also determine the effect of the ratio on the coefficient of thermal expansion (CTE) for the polymers.

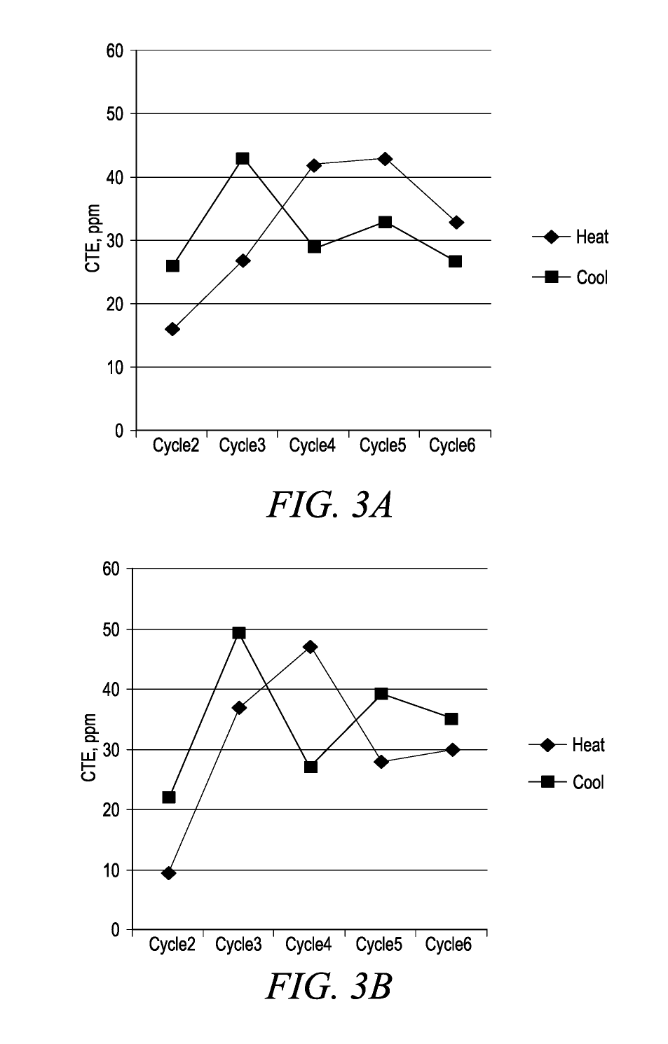

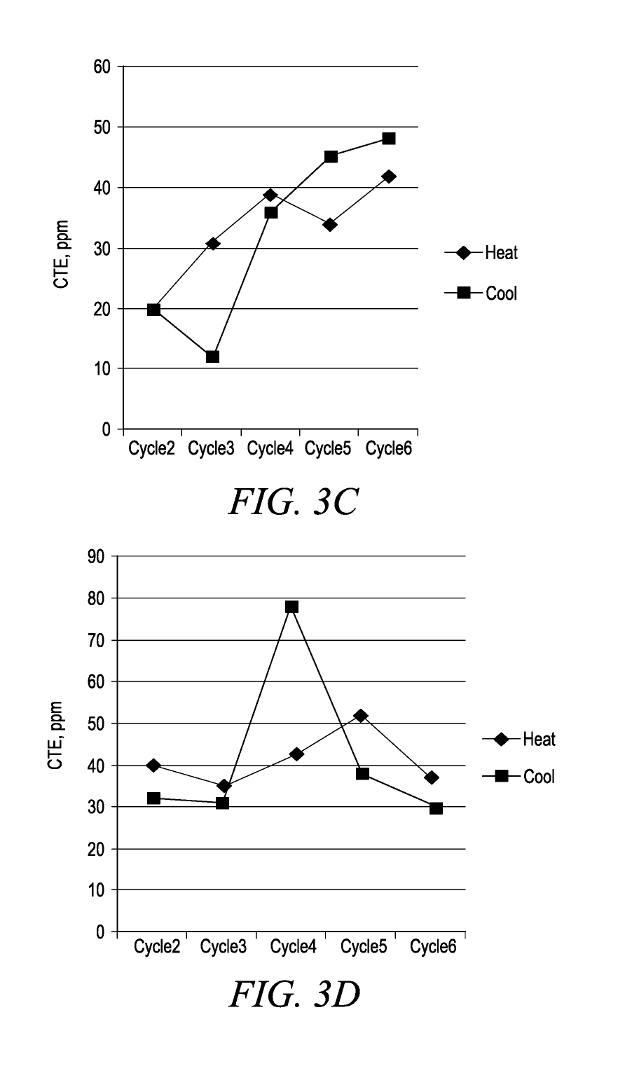

FIG. 3A provides the CTE data of Formulation 2 as described in Example 1 in the modeled quenched case and undergoing subsequent process cycling. FIG. 3B provides the CTE data of Formulation 3 as described in Example 1 in the modeled quenched state and undergoing subsequent process cycling. FIG. 3C provides the CTE data of Formulation 1 as described in Example 1 in the modeled quenched state and undergoing subsequent process cycling. FIG. 3D provides the CTE data of Formulation 4 as described in Example 1 in the modeled quenched state and undergoing subsequent process cycling.

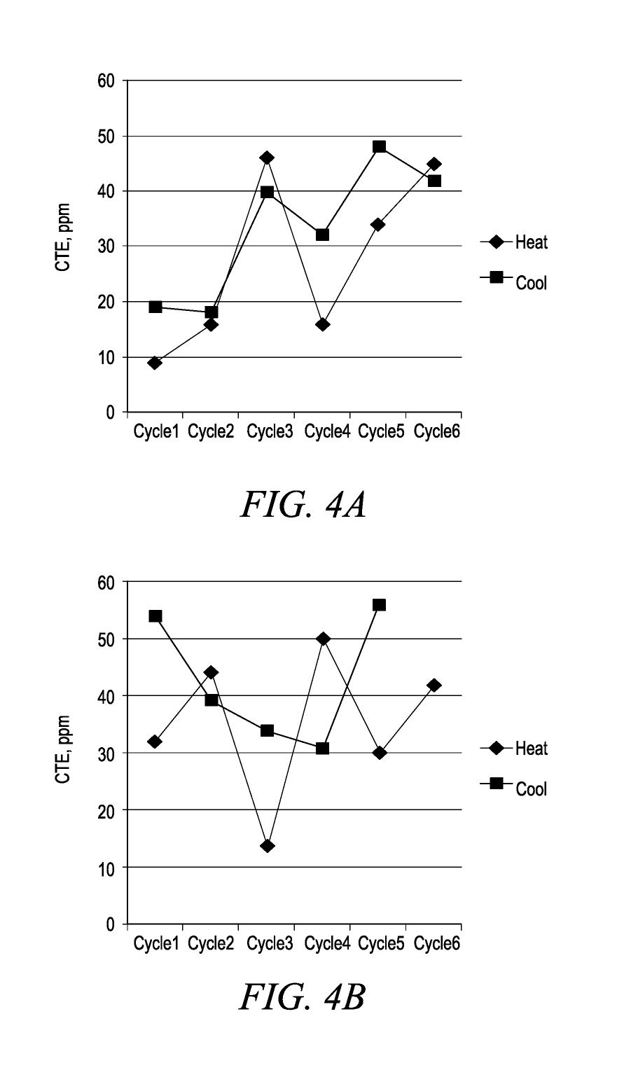

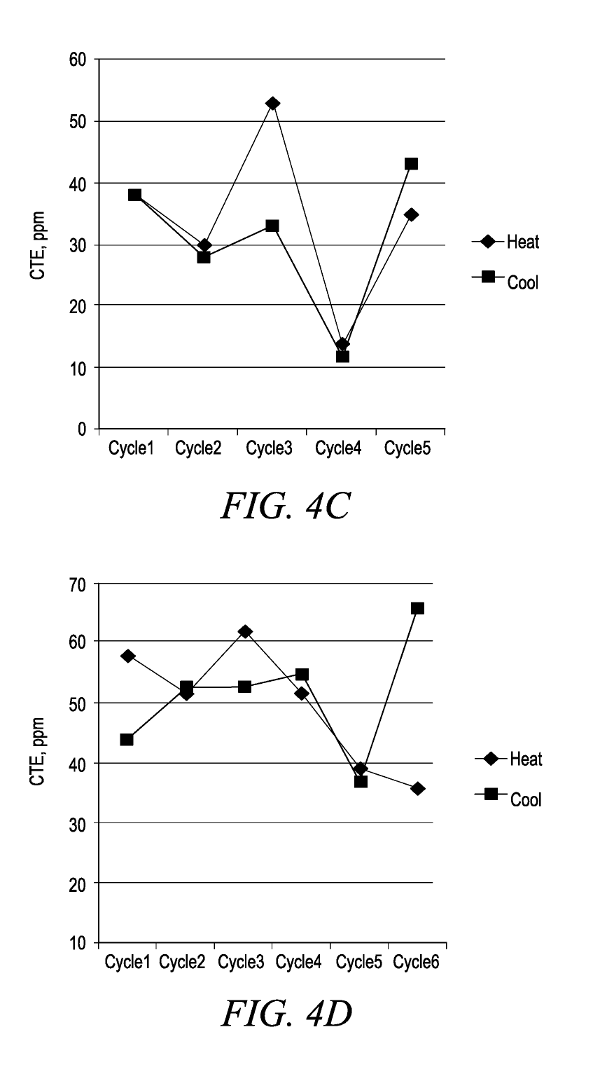

FIG. 4A provides the CTE data of Formulation 2 as described in Example 1 in the modeled equilibrated case and undergoing subsequent process cycling. FIG. 4B provides the CTE data of Formulation 3 as described in Example 1 in the modeled equilibrated state and undergoing subsequent process cycling. FIG. 4C provides the CTE data of Formulation 1 as described in Example 1 in the modeled equilibrated state and undergoing subsequent process cycling. FIG. 4D provides the CTE data of Formulation 4 as described in Example 1 in the modeled equilibrated state and undergoing subsequent process cycling.

FIGS. 3A-D show the CTE data for compounds with various crosslinking and phenyl to methyl ratio combinations in the quenched case. As shown in FIG. 3A, CTE data for Formulation 2 converged to a CTE value of 30-40 ppm. The CTE behavior of Formulation 2 was similar to Formulation 3 as shown in FIG. 3B, but differed from the CTE behavior of Formulation 1, which does not appear to converge to a CTE value and expected to get worse with cycling, as shown in FIG. 3C. The data of FIGS. 3A-C show the stability imparted by either a high phenyl to methyl ratio or crosslinking as discussed previously.

Cross-linking of polysiloxane compounds may also have an effect on the CTE of the polymer in the quenched state. As shown in FIG. 3D, when the compound is thermally quenched, the CTE for Formulation 4 seems to hover around approximately 30-40 ppm similar to the Formulation 2 in FIG. 3A. This differed from Formulation 3, shown in FIG. 3B, as more thermal cycles were needed before the CTE converged to approximately 30-40 ppm.

As shown in FIG. 4A, in the equilibrated case, Formulation 2 had a CTE value that may have increased from its starting state and may be settling in the 40-50 ppm range. The CTE fluctuation range of Formulation 2 is less than the CTE range of Formulation 1 as shown in FIG. 4C, but the fluctuation range of Formulation 1 (FIG. 4C) is similar to the CTE range of Formulation 3 as shown in FIG. 4B. Both Formulation 1 (FIG. 4C) and Formulation 3 (FIG. 4B) have the lower phenyl to methyl ratio of 1:1 than Formulation 2 in FIG. 4A, showing the stabilization impact of the phenyl interactions.

Cross-linking of polysiloxane compounds may also have an effect on the CTE of the polymer in the equilibrated state. As shown in FIG. 4D, in the equilibrated thermal cycle for a 3:1 phenyl to methyl ratio for a crosslinked system, Formulation 4 showed CTE fluctuation extents that are lower than the 3:1 uncrosslinked phenyl to methyl compound (Formulation 2, FIG. 4A) demonstrating a stabilizing influence of crosslinking. Also, the fluctuation extents of Formulation 3 (FIG. 4B) is lower than the uncrosslinked case—Formulation 1 (FIG. 4C), also demonstrating the stabilizing influence of crosslinking. Comparing Formulations 3 and 4 (FIGS. 4B and 4D), Formulation 4 (with a higher phenyl to methyl ratio) showed a more behaved response with lower fluctuation in the CTE demonstrating the stabilizing influence of the phenyl interactions.

### Example 3

### Effect of Cross-Linking on Polymer Structure

Samples of polysiloxane compounds with and without crosslinking underwent molecular modeling to study and predict the compositional effects on the performance properties of the compounds after thermal cycling.

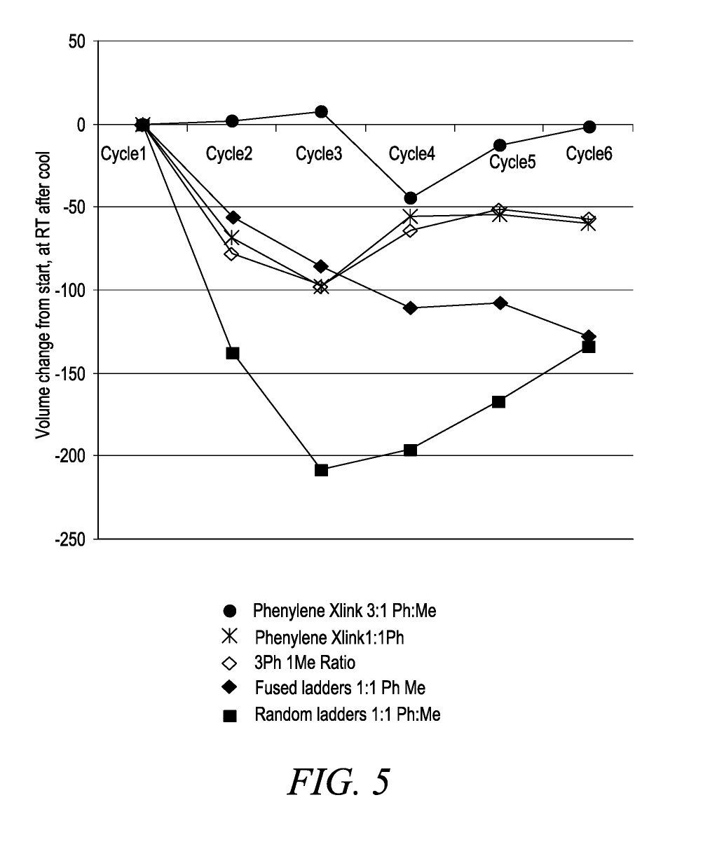

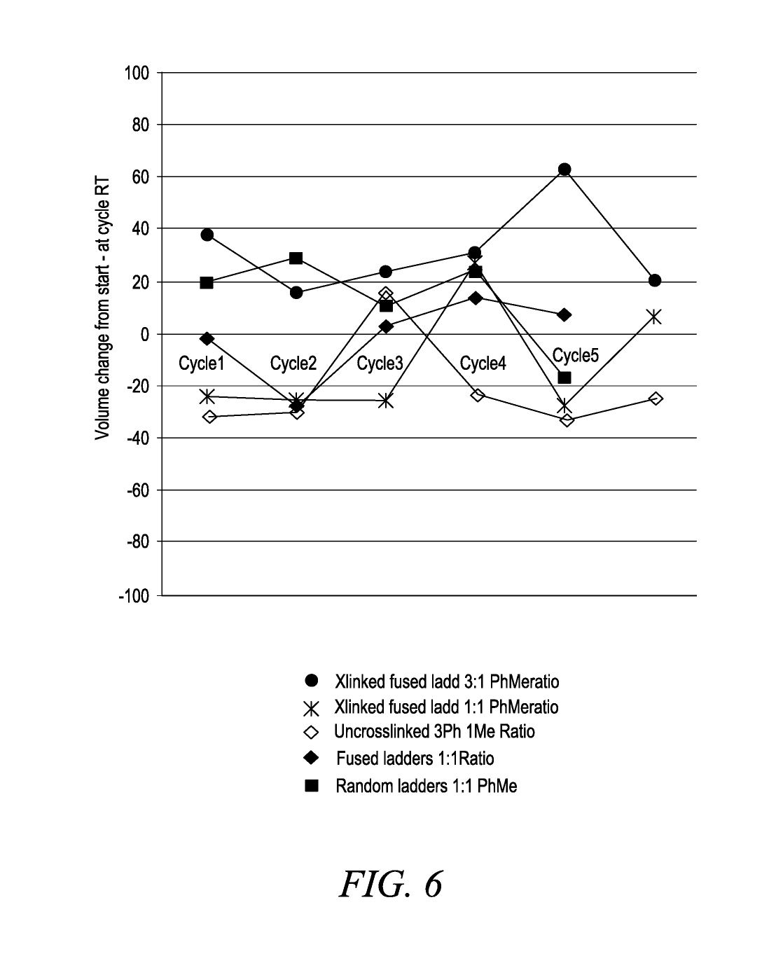

FIG. 5 provides volume change after cooling data for Formulations 1-4 as described in Example 1 in the quenched state and undergoing subsequent process cycling. FIG. 6 provides volume change after cooling data for Formulations 1-4 as described in Example 1 in the equilibrated state and undergoing subsequent process cycling.

As shown in FIG. 5, in the quenched case, both crosslinked compounds (Formulations 3 and 4) showed little volume change at room temperature after cooling. FIG. 5 further shows that Formulation 4 shows the most marked improvement in terms of volume change, i.e. there is little shrinkage in this compound after undergoing multiple thermal cycles after the initial quench as compared to other compounds with different aryl to methyl ratios and/or crosslinking.

As shown in FIG. 6, in the equilibrated case where the volume fluctuations present are less dramatic than the quenched case, the data shows that by adding crosslinkages into the 3:1 aryl to methyl compound—Formulation 4—results in some expansion of the compound with cycling indicating that there is some repulsive interaction occurring with too high of a phenyl content which is exacerbated with crosslinking as it forces the phenyl groups into closer proximity. Lowering the phenyl content creates cycling that is low both with and without crosslinking further showing the thermal history dependence of the formulation.

In comparing the quenched and equilibrated cases, when Formulation 4 was quenched, the maximum shrinkage experienced by the compound was approximately 50 ppm, but when the compound was in the equilibrated case, there was a slight expansion with a maximum expansion of approximately 50 ppm. Since both cases represent extremes of the polymer state when cycled, it is possible that an intermediate quenched state may rebalance the stress states experienced to minimize either the tensile or compressive responses during temperature cycling.

### Example 4

### Effect of Crosslinking on CTE and Volume Change of Polymer

Comparing Formulations 1 and 3 of FIGS. 3C and 3B, respectively, the CTE of Formulation 1 continues to rise and is expected to either get worse with cycling or stabilize at a high CTE level. By contrast, Formulation 3, as shown in FIG. 3B, has a CTE that appears to have stabilized at a lower CTE level. This shows a stabilizing impact of crosslinking.

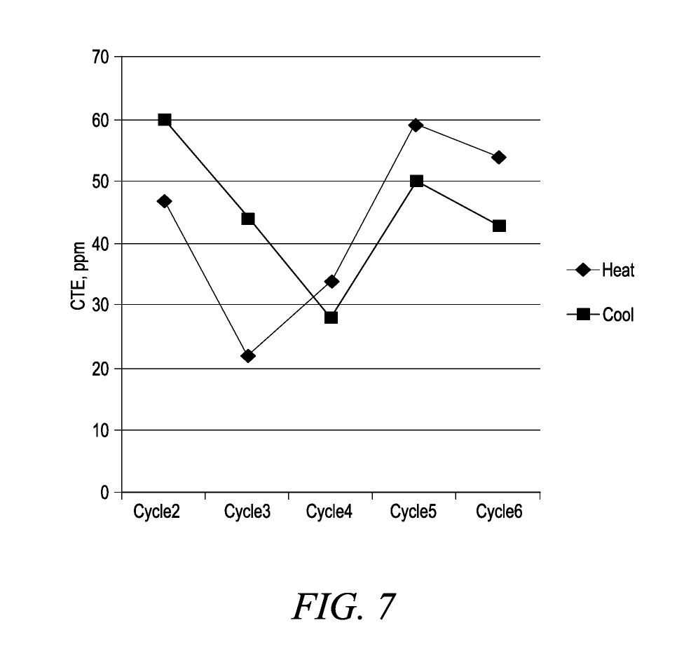

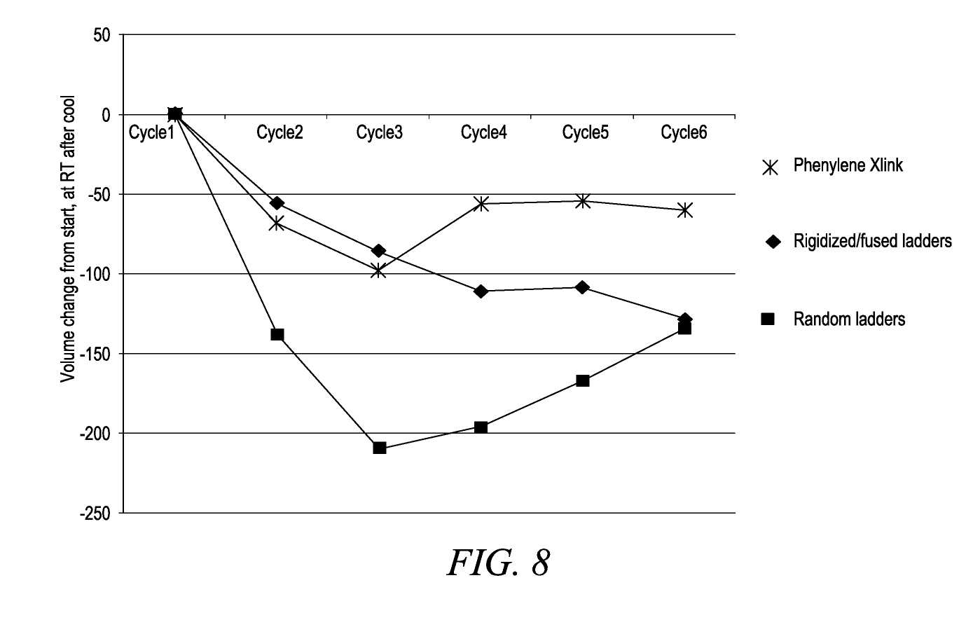

FIG. 7 provides CTE data for a compound that has a randomized uncrosslinked ladder structure, in the quenched state with a phenyl to methyl ratio of 1:1 undergoing subsequent process cycling. In this case, the randomized ladder structure is less rigid than the fused ladder structures, which seem to cycle in CTE rather than stabilize CTE. The impact of high CTE cycles is shown in FIG. 8, which provides volume change after cooling data for compounds that have crosslinking, fused ladders, or a randomized ladder structure in the quenched state and undergo subsequent process cycling. The data shows that the samples with less rigid randomized ladder structures show the highest shrinkage of the structures, which shows that rigidity of the system may be imparted by the architecture itself or by crosslinking.

Quenched Case

As shown in FIGS. 3B, 3C, 7, and 8, in the quenched thermal cycle, compounds with fused ladders but not cross-linked show a CTE value that may converge to approximately 40-50 ppm. Compounds with fused ladders and crosslinking showed CTE values converging to approximately 30-40 ppm, and compounds with random ladders show fluctuating CTE values, i.e. there was no convergence shown in the CTE data.

The crosslinked compounds offered structural stability over many cycles by having the lowest volume change over multiple thermal cycles as compared to fused ladders without crosslinking and random ladders data.

Equilibrated Case

As shown in FIGS. 4B, 4D, in the equilibrated thermal cycle, no clear trend was evident as the CTE value for the fused crosslinked compounds fluctuated over cycling.

FIG. 6 shows that if the initial polymer is equilibrated, the crosslinked case (Formulation 3 or 4) did not reduce the volume shrinkage any better than the other cases (fused ladders and random ladders) after thermal cycling.

Comparison of Quenched and Equilibrated Cases

In comparing the quenched and equilibrated cycling cases, FIGS. 5 and 6 showed that the equilibrated case (FIG. 6) has the least fluctuation in volume change so the thermal history of the compound is significant. The crosslinked compound (Formulation 3 or 4) helped to moderate the volume change in the quenched thermal history. For the 1:1 aryl to methyl compound, crosslinking can decrease the impact of a quenched thermal history—crosslinking resulted in a significant difference in the volume changes between the compounds. However, crosslinking did not seem to alter the equilibrated thermal history—crosslinking did not result in significant differences in the volume changes between the compounds.

The highest shrinkage trend has been found with the case where the polymer has been quenched from a high temperature. The case in which the polymer has been equilibrated at room temperatures exhibited significantly less shrinkage. This suggests that the polymer is sensitive to thermal conditioning that can lead to a stress state in which shrinkage becomes progressively worse with thermal cycling. The thermal conditioning can arise from the conditions of the initial cure and cooling history, but can also arise during subsequent integration processes and thermal histories which build-in the high stress state.

### Example 5

### Effect of Block Substitution Thermal Cycle on Polymer Structure

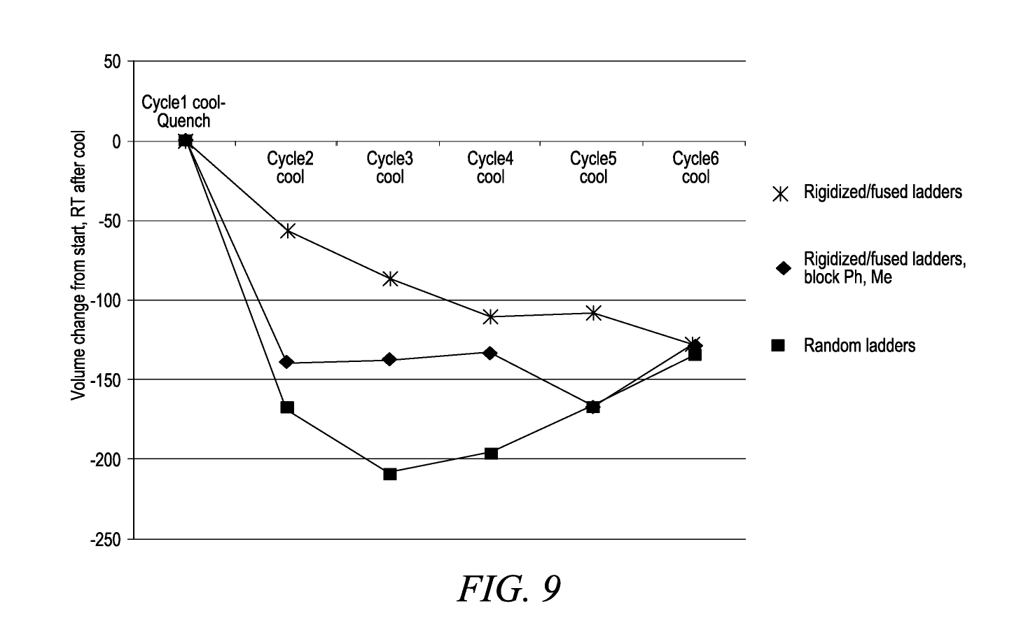

FIG. 9 provides volume change after cooling data for compounds that have fused ladders, fused ladders with block substitution, or a randomized ladder structure in a quenched state and undergoing subsequent process cycling.

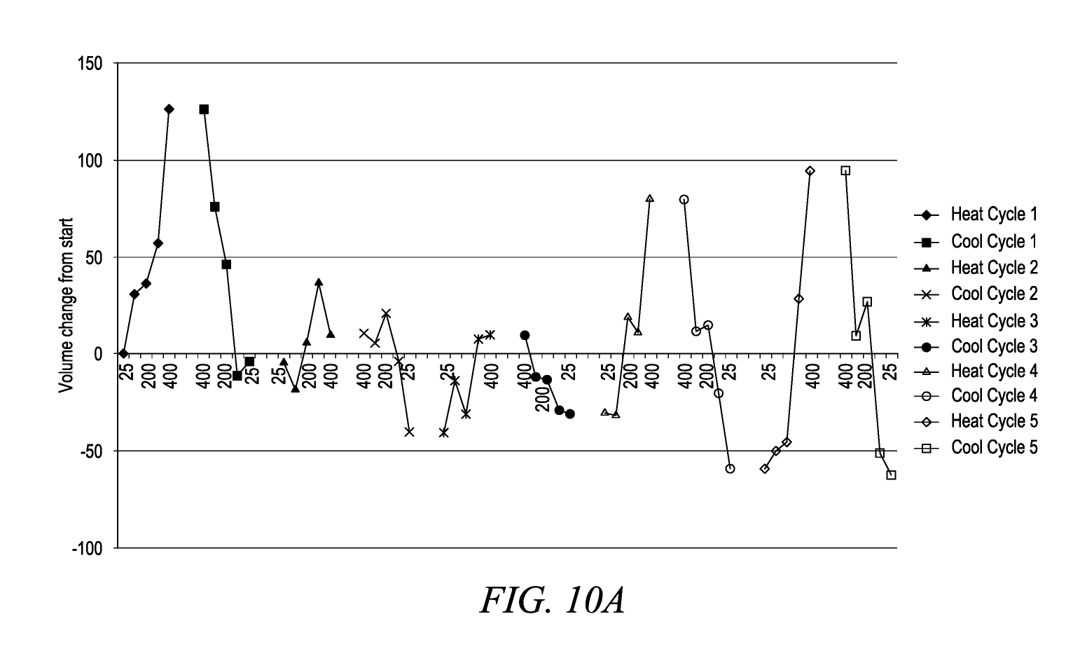

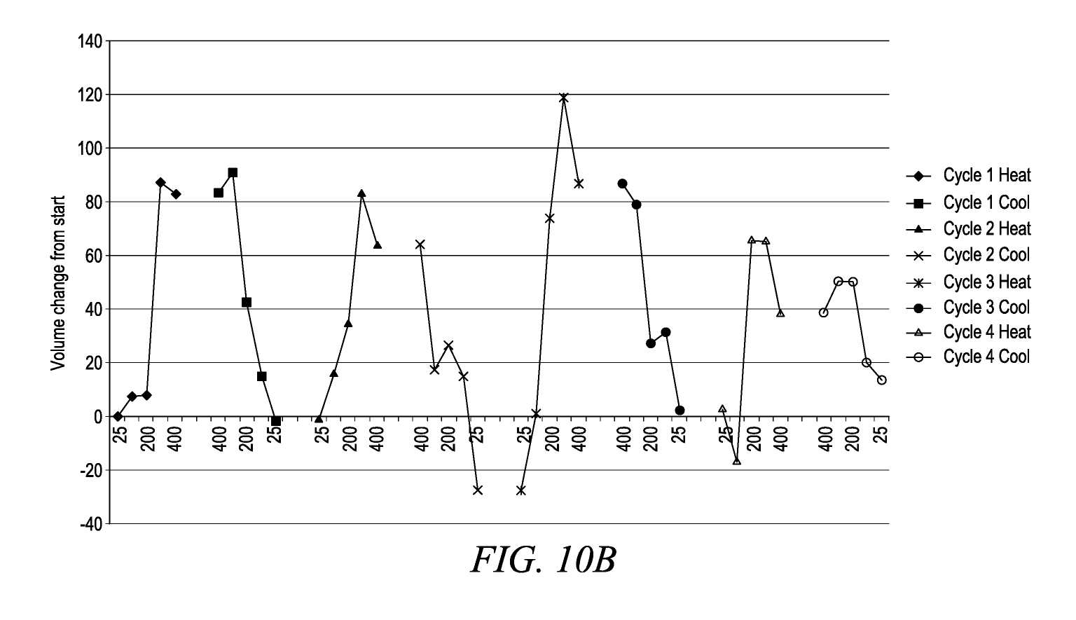

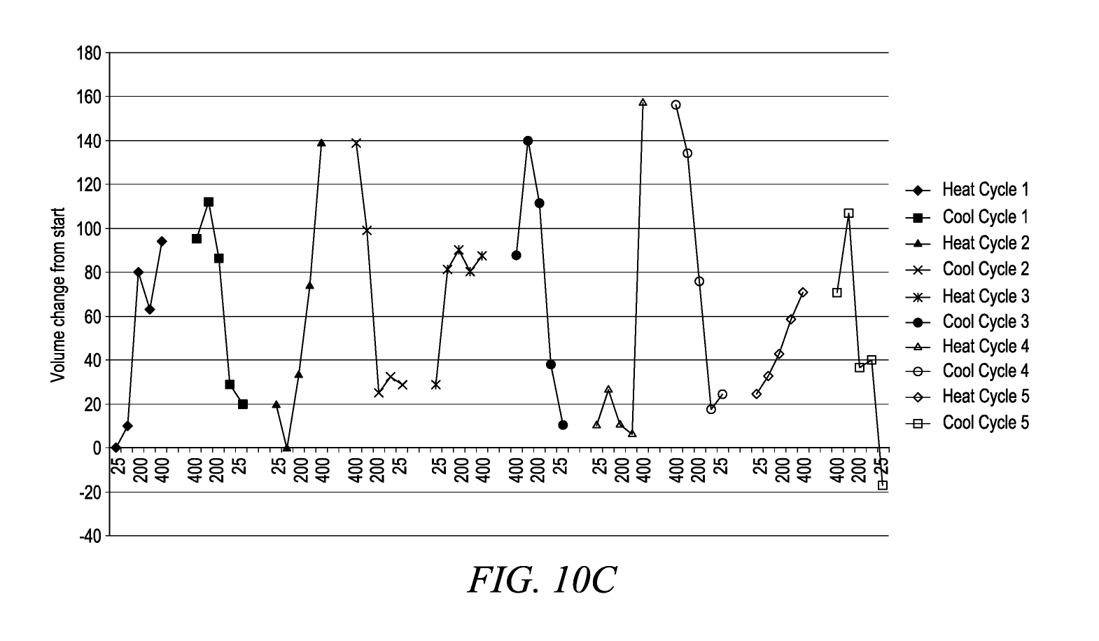

FIG. 10A provides volume change after cooling data over 5 thermal cycles for a compound that has a rigidized/fused ladder with block substitution in the equilibrated state and undergoing subsequent process cycling. Structurally, block substitution means that all of the phenyl groups are next to one another in a block, and all the methyl groups are together in another block. FIG. 10B provides volume change after cooling data for 5 thermal cycles for a compound that has a rigidized/fused ladder structure with no block substitution as related to phenyl and methyl placement in the equilibrated state and undergoing subsequent process cycling. FIG. 10C provides volume change after cooling data for 5 thermal cycles for a compound that has a randomized ladder structure with no block substitution as related to phenyl and methyl placement in the equilibrated state and undergoing subsequent process cycling.

As shown in FIG. 9, in the quenched case, each case shows an immediate large shrinkage after cycle 1 followed by smaller changes in shrinkage thereafter in subsequent cycles. The random ladders and the fused ladders, block aryl-methyl substitution compounds were recovering from high shrinkages, while the fused ladders seemed to show stabilized shrinkage. The biggest difference among the compounds is the fluctuation in volume at the early cycles. The more rigid structures had the lowest fluctuation in volume change, but were more resistant to further annealing of the shrinkage over subsequent cycles.

FIGS. 10A-C show the equilibrated case, the block substitution polymer case exhibited a net shrinkage over thermal cycling. This is less desirable for an equilibrated state.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the above described features.

The following is claimed:

1. A composition comprising:
a solvent;
a catalyst;
a polysiloxane including methyl and phenyl pendant groups; and
a crosslinker comprising at least one of a phenylene disilyl group and para-disilyl phenylene group.

2. The composition of claim 1, wherein the crosslinker is selected from the group consisting of 1,4 bistriethoxysilyl benzene and 1,3 bistriethoxysilyl benzene, 2,6-bis(triethoxysilyl)-naphthalene, 9,10-bis(triethoxysilyl)-anthracene, and 1,6-bis(trimethoxysilyl)-pyrene.

3. The composition of claim 1, wherein a ratio of phenyl pendant groups to methyl pendant groups is from greater than 1:1 to less than 10:1.

4. The composition of claim 1, wherein the ratio of phenyl pendant groups to methyl pendant groups is from 2:1 to 4:1.

5. The composition of claim 1, wherein the ratio of phenyl pendant groups to methyl pendant groups of the composition is between 1:1 and 3:1.

6. The composition of claim 1, wherein the ratio of phenyl pendant groups to methyl pendant groups of the composition is 2:1 or greater.

7. The composition of claim 1, wherein the ratio of phenyl pendant groups to methyl pendant groups of the composition is 3:1 or greater.

8. The composition of claim 1, wherein the catalyst is a heat-activated catalyst.

9. The composition of claim 1, further comprising at least one surfactant.

10. The composition of claim 1, further comprising at least one adhesion promoter.

11. The composition of claim 1, wherein the composition is a crosslinkable composition.

12. A crosslinked film formed from the composition of claim 11.

13. The crosslinked film of claim 12, wherein the crosslinker forms bonds between silicon groups of the polysiloxane.

14. A device comprising a surface, the surface including a crosslinked film according to claim 12.

15. The device of claim 14, wherein the device is selected from the group consisting of a transistor, a light-emitting diode, a color filter, a photovoltaic cell, a flat-panel display, a curved display, a touch-screen display, an x-ray detector, an active or passive matrix OLED display, an active matrix think film liquid crystal display, an electrophoretic display, a CMOS image sensor, and combinations thereof.

16. The device of claim 14, wherein the crosslinked film forms a passivation layer, a planarization layer, a barrier layer, or a combination thereof.

17. A method of forming a coating on a substrate, the method comprising:
providing a composition including a solvent, a catalyst, a polysiloxane including methyl and phenyl pendant groups; and a crosslinker comprising at least one of a phenylene disilyl group and para-disilyl phenylene group; and depositing the composition on the substrate.

18. The method of claim 17, further comprising curing the coating, wherein curing the coating includes forming bonds between silicon groups of the polysiloxane with the crosslinker.

19. The method of claim 17, wherein the crosslinker is selected from the group consisting of bis silyl benzene, bis alkoxysilane, 1,3 bistriethoxysilyl benzene, and 1,4 bistriethoxysilyl benzene 2,6-bis(triethoxysilyl)-naphthalene, 9,10-bis(triethoxysilyl)-anthracene, and 1,6-bis(trimethoxysilyl)-pyrene.

20. The method of claim 17, wherein a ratio of phenyl pendant groups to methyl pendant groups is 2:1 or greater.
